(19) United States
(12) Patent Application Publication
(10) Pub. No.: US 2006/0151393 A1
(43) Pub. Date: Jul. 13, 2006

(54) Water purification and disenfection device and method

(76) Inventor: Timothy J. Badger, Scituate, MA (US)

Correspondence Address: WELSH & KATZ, LTD, 120 S RIVERSIDE PLAZA, 22ND FLOOR, CHICAGO, IL, 60606, US

(21) Appl. No.: 11/320,199

(22) Filed: Dec. 28, 2005

Related U.S. Application Data
(60) Provisional application No. 60/643,919, filed on Jan. 7, 2005.

(51) Int. Cl. C02F 1/44

(52) U.S. Cl. 210/652

(57) ABSTRACT

A water treatment system for use in situations where power means, such as electricity, are either non-existent, too expensive or temporarily unavailable, for example due to catastrophic circumstances, is provided. The system includes means to create pressure that drives raw water through preselected treatment media so as to purify and filter water, particularly brackish water, so that it is made potable. The system includes the use of physical and chemical treatment means, including carbon, reverse osmosis and anti-microbial media.

This application claims the benefit of U.S. provisional application Ser. No. 60/643,919 filed Jan. 7, 2005, the entirety of which is incorporated herein by reference as though set out here in full.

### FIELD OF THE INVENTION

The present invention concerns a device and method for purifying and disinfecting water. More particularly the present invention concerns a device that produces potable water but does not use conventional power sources, such as electricity, to cause water to be pumped through filtration and disinfection media. The present invention also includes a method for using the device.

### BACKGROUND OF THE INVENTION

In places where electric power service is in short supply, or is overly expensive, or does not exist, either as a result of temporary power outages or the non-existence of service at the location (such as rural outposts), the production of potable water in sufficient quantities can be hampered. Purification and disinfection of water sources typically requires power to push water through appropriate filtration mechanisms. In the case of a severe catastrophic occurrence, such as a natural disaster, power supplies are often affected and natural or local water supplies can be contaminated such that fresh potable water is unavailable. Recovery from such occurrences is typically hampered by the same conditions that caused the shortage and disease can be spread from the use of contaminated water supplies.

In modern times, the response to outages and disasters has been to transport purified water, in small unit containers such as bottles, to the affected areas. Such transportation is extremely costly and is limited in that often very remote areas cannot be quickly reached with sufficient quantities of bottled water in a timely manner. Further, because of the actual weight of bottled water and the logistics of transporting large quantities over great distances, sufficient supplies are usually delayed until illness and disease has already occurred. Further, there is an inherent danger in transporting any product into areas where disasters have occurred and/or are still occurring.

It would be desirable to provide an inexpensive device that could be used to purify water that exists at the site of the shortage of potable water. Further, it would be desirable to have a device and method for purifying water that is easy to use, light-weight and portable and require no local power service to operate.

### SUMMARY OF THE INVENTION

In accordance with the present invention, a water purification and disinfecting device having mounting means for various proprietary filtering means, including but not limited to one or more particulate removal and disinfecting media, reverse osmosis membrane materials, microbial removal media and others, is provided. The device further comprises means, preferably manually operated, for pumping water from a source through the various media such that the water is desalinized, purified and disinfected to potable. It will be understood by persons having ordinary skill in the art that although ultimately potable water is desired, various degrees of water purity, for purposes other than human consumption, can be achieved using only some of the filtering media described, without departing from the novel scope of the present invention. Water for washing or for agricultural use can be purified to a degree less than potable by using the device of the present invention with a prescribed number of filter media at a lower cost than the production of water for human consumption.

In a first preferred embodiment, a device of the present invention is provided with a tank having a liquid storage volume and a pressurization volume, the pressurization volume being formed within an air impermeable bladder. The tank further has at least one water inlet and at least one water outlet. The device includes means to pressurize the air impermeable bladder, preferably by manual action such as by a foot pump, or other non-motorized means including, but not limited to, such things as animal power and/or other mechanical or gravity means, so that upon pressurization, water in the tank is forced out from the tank through the at least one water outlet. The device includes treatment media in the form of water purification means and water disinfecting means attached to the at least one water outlet. In one embodiment, the purification and disinfecting means are placed in series such that the water first passes through one and then another of the purification and/or disinfecting means. Depending on the initial quality and salinity of the water, any number of treatment media elements can be used.

In the present embodiment, the treated water is then placed in a water storage and dispensing device, such as a water cooler or other suitable holding tank. The storage and dispensing device receives water from the purification and disinfection media and stores the water until it is needed.

In a preferred embodiment of the present invention, an air bladder in combination with a low pressure pump such as a foot or bicycle type pump is used to produce sufficient pressure to force water through the treatment media. By the use of a pump and air bladder to produce pressure, water is forced through the treatment medium using no electric power. Such a system can be used substantially anywhere.

In another embodiment of the present invention the water purification and disinfecting device is made in a gravity feed arrangement, such that water flows from an upper storage tank down through filtration, disinfecting and purification media into a storage and dispensing device.

In another embodiment a small pump is utilized to push water through the purification and disinfecting means.

A more detailed explanation of the invention is provided in the following description and claims and is illustrated in the accompanying drawings.

### BRIEF DESCRIPTION OF THE DRAWINGS

In the drawings forming a portion of this disclosure,

FIG. 1 is a schematic representation of a device of the present invention.

FIG. 1A is a schematic representation of a pressure tank with bladder used in one embodiment of the device of the present invention.

FIG. 2 is a schematic representation of the foot pump and pressure tank of the device of FIG. 1.

FIG. 3 is a schematic representation of another embodiment of the device of the present invention.

FIG. 4 is a schematic representation of the water purification steps taken by one embodiment of the present invention.

FIG. 5 is a schematic representation of a gravity feed version of the device of the present invention.

### DETAILED DESCRIPTION OF ILLUSTRATIVE EMBODIMENTS

Although the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

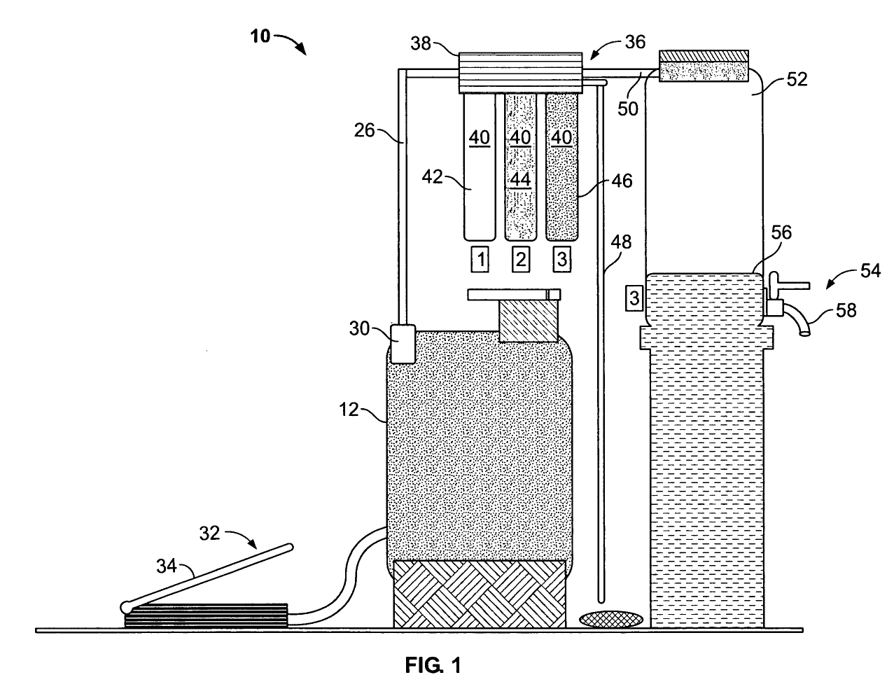

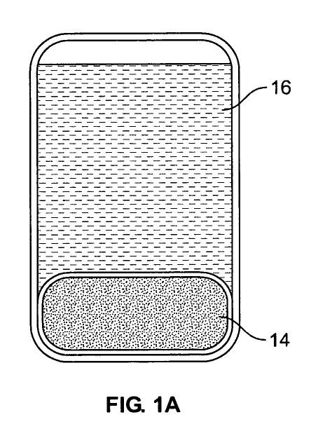

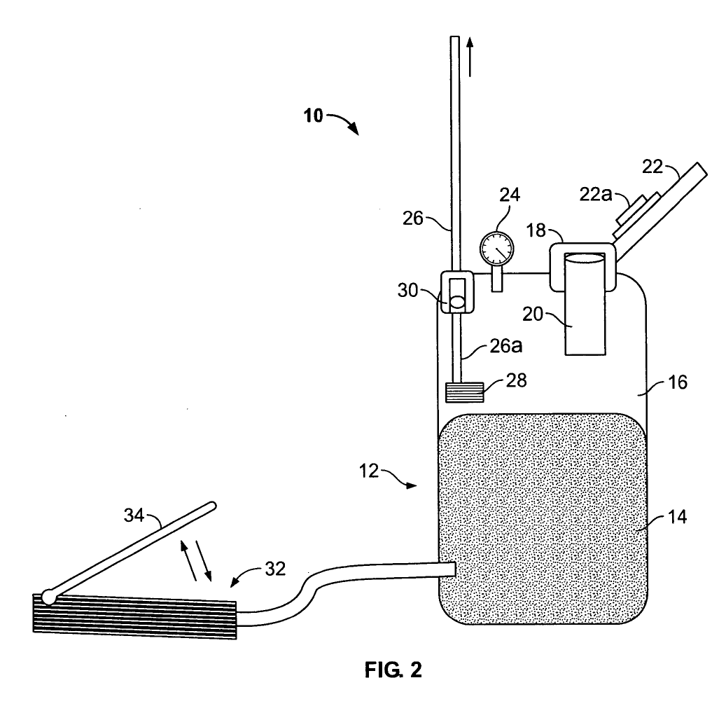

Referring to the drawings, FIG. 1 shows a schematic representation of one embodiment of the device of the present invention. It will be seen that the water treatment system 10 of the embodiment of FIG. 1 comprises a tank 12 capable of pressurization. Tank 12, as more clearly shown in FIG. 2, comprises a solid structure capable of holding liquids. Tank 12 further comprises a bladder 14 and a water holding volume 16, which can be seen in greater detail in FIG. 1A. In a preferred embodiment, bladder 14 is made of butyl rubber material that gives the bladder a particular springiness that provides an appropriate amount of pressure when used in the present invention. Bladder 14 can, however, be created using any appropriate material, which will provide the desired pressure to the system, without departing from the novel scope of the present invention.

Other elements of tank 12 include a fill port 18 having a fill neck 20, through which raw water, such as brackish water, microbially-contaminated water or the like, can be placed within tank 12. Fill port 18 includes a cover 22 having a pressure seal 22a, preferably a posi-lock type seal.

Pressure seal 22a permits tank 12 to be pressurized in a manner described below, to permit the flow of water through filter media. Advantageously, a pressure gauge 24 is included to permit the user to apply optimal pressure for the purification task. Tank 12 includes a water outlet tube 26 having a particulate screen 28 adjacent the proximal end 26a of tube 26. A check valve 30 is included in the path of tube 26 so that water leaving tank 12 cannot return to tank 12. The other elements of tank 12 described in this paragraph are shown for illustrative purposes and it will be understood by persons having skill in the art that various variations, modifications and/or substitutions for those parts can be made without departing from the novel scope of the present invention.

System 10 further comprises a means 32 to pressurize the gas, preferably air, in tank 12. In one embodiment pressurizing means is a foot pump 34, however, any means to pressurize tank 12, including the use of different types of manual, wind, water or battery powered pumps, can be substituted without departing from the novel scope of the present invention. It is however a requirement of any such pressurization means that pressure sufficient to permit water to be forced through the water treatment media be developed. In the present example the foot pump 34 generates, in combination with bladder 14 a pressure of at least about 150 psi (or about 10.55 kgs/sq.cm) in order to force water from the tank through the filtration and purification media selected, as will be described below. It will be understood that the pressure required to charge the system will vary depending on a number of factors, well known to persons having ordinary skill in the art. Desirable pressures of from 20 psi to 200 psi are typically required to perform the purification of water described herein.

In an example of a pressure tank with bladder, as shown in FIG. 1A, of the present invention, a tank 16 has a volume of 80.5 liters is used in combination with a bladder having an expanded volume of 100 liters. The fill volume of water for such a set up is 60 liters with an average RO (reverse osmosis) reject stream of about 40 liters per use; having an ability to filter 20 liters of water per use. Such a tank can be made with a height of 61 cm and a diameter of 41 cm. It will be understood by persons having skill in the art that any number of modifications can be made to such a tank, depending on desired or required parameters, without departing from the novel scope of the present invention.

Referring again to FIG. 1, it will be seen that this embodiment of the present invention includes a three stage treatment unit 36. The three stage treatment unit 36 comprises a universal manifold 38 into which treatment media 40 can be attached. Attachment of the media to the manifold can be through screw type, bayonet or other type mounting means, all well known in the art.

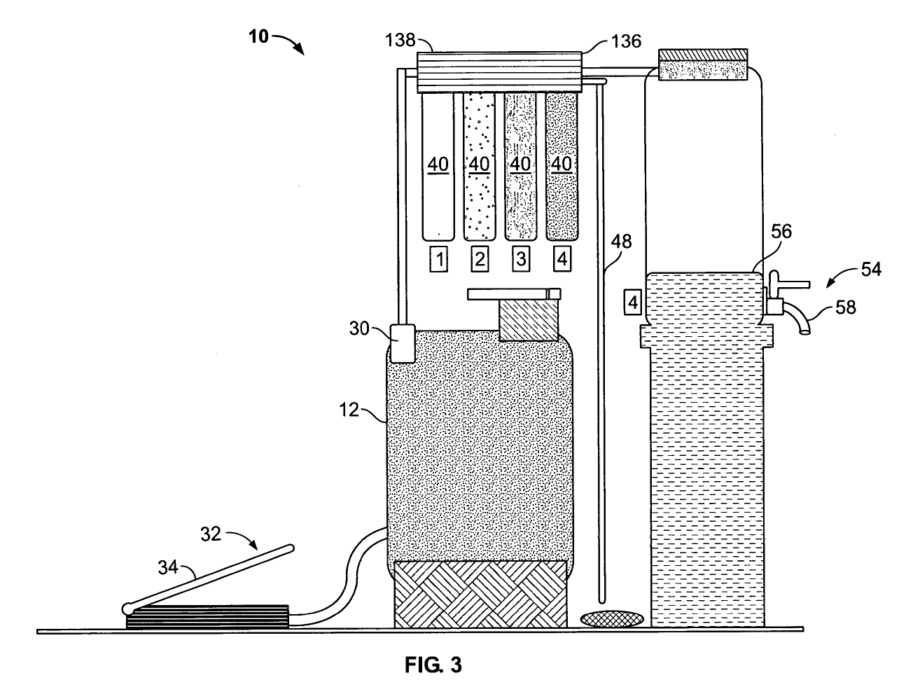

The universal manifold of the present embodiment includes openings for each of the selected treatment media and has means to direct water into the media such that the water can most efficiently pass through and be treated by the media. Further, the manifold 38 of the present invention is designed so that water is forced through each of the attached media in a series formation, that is the water progresses first through one treatment media before proceeding to the next media until the desired purity and cleansing is achieved. Referring briefly to FIG. 3, a four stage treatment unit 136 is shown having a manifold 138 comprising means for attachment of four treatment media is shown. Treatment media 136 can be configured similarly to treatment unit 36, with the addition of one more filter stage (which can be of a different type or can be duplicative of another used prior). For ease of understanding, like elements of unit 138 will be numbered identically to those shown in FIG. 2 for unit 38. It will be understood by persons having ordinary skill in the art that, in a similar manner, any other number of filtering stages can be used, as required by the level of water purity, without departing from the novel scope of the present invention.

In the present example the three stages include a first particulate removal disinfection media 42, a reverse osmosis (R/O) thin wall membrane media 44 and a coconut shell carbon disinfection media 46. It will be understood by persons having ordinary skill in the art that the types and numbers of filtering and disinfecting media 40 used will be based on the initial condition of the water to be treated. For example, different levels of salinity (brackishness), chemicals, heavy metals and other contaminants can help determine the type of R/O membrane and the frequency with which it will be replaced or renewed during treatment. Further, water having no initial odor or taste requires less treatment than malodorous or bad tasting water requires. The third stage 46 of the treatment shown in FIG. 1 is designed to brighten the water and remove any bad tastes or smells so that the water is aesthetically pleasing to the consumer.

It will be understood that filtration, purification and other treatment media of the type described are available from a plethora of sources and manufacturers, many of which provide such media in forms suitable for attachment to a universal manifold 38 such as the one described. It will also be understood that raw media is also available and that such media can be placed into appropriate containers to recharge, clean and/or create appropriate filter media.

With respect to particulate and disinfection media, it is recommended that one or more of the anti-microbial and oxidative co-polymer media that are disclosed in U.S. Pat. No. 6,921,739 B2 be utilized. That patent is incorporated, by reference, herein in its entirety. Such media provide anti-microbial disinfection without the use of chlorine. It will be understood, however, that use of other particulate and disinfection media can be utilized without departing from the novel scope of the present invention.

System 10 further includes a means to drain rejected water elements from the system through a drainage pipe 48. Treated water emerges from the treatment manifold 38 through a pipe 50 into a storage and dispensing device 52, such as a water cooler 54. In the present invention, cooler 54 includes a final stage of filtrations, such as another course of coconut shell carbon/disinfection media 56. The placement of media 56 permits the final stage of purification to occur precisely at the time that water is dispensed from cooler 54 through a spigot 58. This final stage of filtration can be dispensed with as desired, without departing from the novel scope of the present invention.

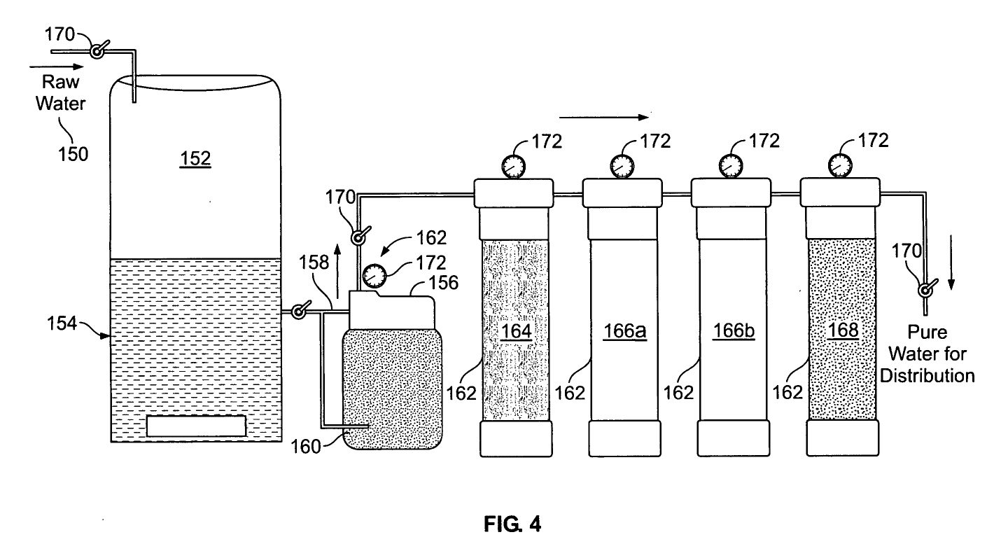

Referring now to FIG. 4, a schematic showing another embodiment of the progression of water treatment is shown. Raw water 150 is placed into the raw water holding tank 152. The purpose of this atmospheric tank is to collect and hold large volumes of water. A debris screen 154 is placed in the bottom of this tank to separate out suspended solids. In the present embodiment, and others envisioned as being within the novel scope of the present invention, a means to move water including a small pump is utilized. In the present embodiment, a ½ to ¾ horse power pump 156 is connected to a valved pipe 158 fitted to the bottom of the raw water tank 150. A pressure tank 160 with pressure switch 162 is installed to the pump assembly 156. A pressure of 20 to 40 psi is maintained as the water is pushed through various media filters 162. In particular the filters 162 can contain any one or all of the following combinations of media: a particulate pre-filer 164; one or more disinfecting tanks 166a and 166b; and a post-filter carbon media 168.

In the present embodiment, valves 170 and pressure gauges 172 are used between tanks and media filters. In one embodiment a ball valve is used, however, it will be understood by persons having ordinary skill in the art that other types of valves and pressure measuring means can be used (or in some embodiments eliminated) without departing from the novel scope of the present invention.

Purified water emerging from this system is then pumped directly for distribution into a dedicated storage tank (not shown).

It will be understood that the treatment media of the present invention, as described below, can be used in association with a gravity-fed system wherein water is pumped or collected at a higher level and permitted to drop into the system, through a water tube, such as tube or pipe 26, in such a manner that similar pressures, to those that can be developed with a pump, are developed through the falling action of the water. One such system is described below.

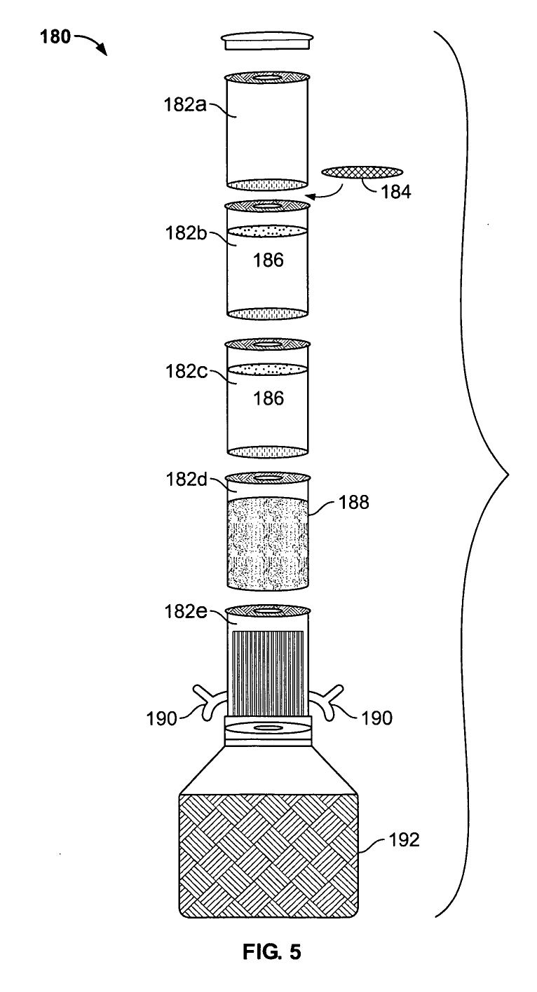

Referring to FIG. 5, a schematic representation of a gravity-fed version of the device 180 of the present invention is shown. In this embodiment, five 5 gallon capacity pails 182, preferably made of plastic and being tapered from the top to the bottom, are used. Each pail 182 has its bottom modified by containing a pattern of small holes in it (not shown). In one embodiment, a filter pad 184 (preferably made of cloth) is placed on top of the holes. Clean sand or small stones (1″ thickness) may be placed on top of the filter pad 184 to help anchor the pad. In one embodiment, the first and fourth pails 182, pails 182a and 182d, are constructed in this manner, whereas the second, third and fifth pails 182b, 182c and 182e have filtration media 186 added on top of the prepared pail with holes, filter pad and sub-filter media. In one embodiment ½ cubic foot of ATSDM2006 media is located in the second and third pails, respectively 182b and 182c. The fourth pail 182d has ½ cubic foot of coconut shell carbon media 188.

The last pail in this series 182e, in the present embodiment, does not have holes formed in its bottom. Instead one or two faucets 190 are installed 1½″ to 2″ from the bottom edge. The pail assembly 181 is located on a platform 192 that permits clearance for water collection vessels to easily be located at each tap 190. The pails 182 are “nested” one on top of another. The tapered pail shape permits easy installation and removal. The pails can be temporarily sealed together using tape, such as duct tape, or other means, so as to eliminate any gap(s) or space(s).

The top pail 182a permits water to be added to the TSDM 2006 system 181. Individuals taking purified water from the system must first add to the top raw water reservoir. After contributing the raw water in the top, the individual can take purified water from one of the two faucets 190 on the bottom pail 182e. A large bottom collection vessel can be substituted for the pail indicated in FIG. 5 without departing from the novel scope of the present invention. It will be understood that variations of the gravity fed system, including one whereby a hopper with water is placed above a filtering system similar to those shown in FIGS. 1 and 3, such that water is forced through media by the energy generated by the falling water can be used without departing from the novel scope of the present invention.

Although illustrative embodiments of the invention has been shown and described, it is to be understood that various modifications and substitutions may be made by those skilled in the art without departing from the novel spirit and scope of the invention.

What is claimed is:

1. A liquid purification and disinfecting device comprising:
at least one liquid inlet and at least one liquid outlet;
means to provide force such that upon the exertion of force, liquid is driven from the at least one inlet to the at least one outlet;
first liquid purification means and first liquid disinfecting means each operatively attached to the at least one outlet; and,
liquid storage and dispensing means for receiving and storing liquid, from one or both of the first liquid purification means and the first liquid disinfecting means, until dispensed.

2. The liquid purification and disinfecting device of claim 1 wherein the liquid is water.

3. The liquid purification and disinfecting device of claim 1 including a tank having a liquid storage volume and a pressurization volume wherein pressure from the pressurization volume is utilized to drive the liquid.

4. The liquid purification and disinfecting device of claim 3 wherein the pressurization volume is formed within a bladder.

5. The liquid purification and disinfecting device of claim 4 wherein the bladder is formed of butyl.

6. The liquid purification and disinfecting device of claim 1 wherein the purification means is a reverse osmosis membrane

7. The liquid purification and disinfecting device of claim 1 wherein the disinfecting means is a particulate disinfection media.

8. The liquid purification and disinfecting device of claim 4 wherein the means to provide force includes a low pressure pump to provide a pressure volume within the bladder.

9. The liquid purification and disinfecting device of claim 8 wherein the means to provide force includes a foot pump.

10. The liquid purification and disinfecting device of claim 1 wherein liquid is passed through both the purification and disinfecting means.

11. A water purification and disinfecting device comprising:
a tank having a liquid storage volume and a pressurization volume, the pressurization volume formed within an air impermeable bladder;
the tank further comprising at least one water inlet and at least one water outlet;
means to pressurize the air impermeable bladder such that upon pressurization water in the tank is forced out from the tank through the at least one water outlet;
first water purification means attached to the at least one water outlet;
first water disinfecting means attached to the at least one water outlet; and,
water storage and dispensing means for receiving water from the first purification and first disinfecting means and storing the water until dispensed.

12. The water purification and disinfecting device of claim 11 wherein the purification means is a reverse osmosis membrane

13. The water purification and disinfecting device of claim 11 wherein the disinfecting means is a particulate disinfection media.

14. The water purification and disinfecting device of claim 11 wherein the means to provide force includes a low pressure pump to provide a pressure volume within the bladder.

15. The water purification and disinfecting device of claim 11 wherein liquid is passed through both the purification and disinfecting means.

16. The water purification and disinfecting device of claim 11 wherein the water purification means comprises one or more purifying filter devices.

17. The water purification and disinfecting device of claim 11 wherein the water disinfecting means comprises one or more disinfecting filter devices.

18. A method of providing purified and disinfected water comprising the steps of:
providing a tank having a liquid storage volume and a pressurization volume, the pressurization volume formed within an air impermeable bladder;
providing at least one water inlet and at least one water outlet for the tank;
placing water within the tank;
pressurizing the air impermeable bladder such that water in the tank is forced out from the tank through the at least one water outlet;
purifying the water by passing the water through at least one first water purification means attached to the at least one water outlet;
disinfecting the water by passing it through at least one first water disinfecting means attached to the at least one water outlet;
providing a storage and dispensing means for receiving the purified and disinfected water from the at least one first purification and the at least one first disinfecting means; and,
dispensing the purified and disinfected water.

19. The method of providing purified and disinfected water of claim 18 wherein the purification means is a reverse osmosis membrane

20. The method of providing purified and disinfected water of claim 18 wherein the disinfecting means is a particulate disinfection media.

21. The method of providing purified and disinfected water of claim 18 including the step of providing a low pressure pump to provide a pressure volume within the bladder.
